(19) United States
(12) Patent Application Publication
(10) Pub. No.: US 2009/0055255 A1
(43) Pub. Date: Feb. 26, 2009

(54) INTERACTIVE ELECTRONIC COUPON METHOD AND SYSTEM

(75) Inventors: Andrei Obrea, Seymour, CT (US); Theresa Biasi, Shelton, CT (US); Bradley R. Hammell, Bridgeport, CT (US); Christian Crews, Fairfield, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/844,020

(22) Filed: Aug. 23, 2007

(51) Int. Cl. G06Q 30/00

(52) U.S. Cl. 705/14

(57) ABSTRACT

A system, method, and medium, the method including establishing a relationship between a marketer and a trusted third party; establishing a relationship between a customer and the trusted third party; receiving, by the trusted third party from the customer via an electronic communication, an indication of an expressed interest in an offer by the customer, the expressed interest being an action other than a purchase associated with the offer; and outputting, by the trusted third party, information associated with the indication of the expressed interest in the offer to the marketer.

### BACKGROUND

The present invention is related to marketed offers, and particularly to such systems and methods that provide an interactive offer.

Some conventional offers, such as coupons, mailers, and other print media, provide an indication of when a customer uses the coupon. In particular, a retailer or marketer is able to determine when the customer responds to an offer when the customer makes a purchase using the coupon associated with the offer.

However, a retailer or marketer cannot easily or efficiently determine what interest, if any, a customer has in an offer based on actions other than a purchase associated with the offer. Specifically, short of the customer redeeming the printed coupon associated with the offer to complete a purchase, a retailer or marketer cannot determine with any certainty that the offer piqued any interest in the customer. Without such knowledge of what potential customer interests are driven by the offer, the retailer/marketer is at a loss in refining the offer to better appeal to potential customers. Additionally, surveys and other conventional attempts to track and measure customer action, reaction, and interests other than a purchase to offers and incentives may be costly, inefficient, and unreliable. In some respects, difficulty in determining interests of potential customers is complicated by a desire of customers to maintain a sense of privacy.

Accordingly, it would be desirable to efficiently determine what interest(s) other than a purchase an offer generates from a customer.

### SUMMARY

According to an aspect of the present invention, a method includes establishing a relationship between a marketer and a trusted third party; establishing a relationship between a customer and the trusted third party; receiving, by the trusted third party from the customer via an electronic communication, an indication of an expressed interest in an offer by the customer, the expressed interest being an action other than a purchase associated with the offer; and outputting information associated with the indication of the expressed interest in the offer to the marketer.

In some aspects of the invention, a method includes activation of the offer to a usable form by the trusted third party. The trusted third party may initiate the activation at the direction of the customer. The activated offer may be electronically communicated to a retailer associated with the activated offer.

In some embodiments, the trusted third party may keep private from the marketer at least a portion of customer identifying data based on at least one of the relationship between the customer and the trusted third party, a relationship between the customer and the offer, and the relationship between the marketer and the trusted third party.

In another aspect of the present disclosure, the expressed interest in the offer by the customer may be at least one of viewing of the offer by the customer, saving the offer by the customer, associating the offer with the customer, notifying others of the offer by the customer, comparing the offer with other offers, a request to activate the offer by the customer, declining to participate in the offer by the customer, and combinations thereof.

In some embodiments, the marketer may notify the trusted third party to modify at least one term of the offer. The trusted third party may notify the marketer of customer preferences associated with the offer. In yet another aspect herein, the marketer may notify the trusted third party that the customer has made a purchase associated with the offer.

The present disclosure further relates to methods and systems that may include initiating an auction regarding a plurality of offers on a behalf of the customer by the trusted third party, where the auction is initiated based on the relationship between the trusted third party and the marketer.

In some aspects of the present disclosure, a system including a memory storing processor-executable instructions and a processor in communication with the memory and operative in conjunction with the memory to execute the stored instructions is provided. The processor may be operative to establish a relationship between a marketer and a trusted third party; establish a relationship between a customer and the trusted third party; receive, by the trusted third party from the customer via an electronic communication, an indication of an expressed interest in an offer by the customer, the expressed interest being an action other than a purchase associated with the offer; and output, by the trusted third party, information associated with the indication of the expressed interest in the offer to the marketer.

In some embodiments herein, a medium having machine-executable instructions stored thereon is provided. The medium may include instructions to establish a relationship between a marketer and a trusted third party; instructions to establish a relationship between a customer and the trusted third party; instructions to receive, by the trusted third party from the customer via an electronic communication, an indication of an expressed interest in an offer by the customer, the expressed interest being an action other than a purchase associated with the offer; and instructions to output, by the trusted third party, information associated with the indication of the expressed interest in the offer to the marketer.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention and, together with the general description given above and the detailed description given below, serve to explain the principles of the invention. As shown throughout the drawings, like reference numerals designate like or corresponding parts.

FIG. 1 is a block diagram of a system, according to aspects of the present invention; and

FIG. 2 is a flow chart of an exemplary process, according to aspects herein; and

### DETAILED DESCRIPTION

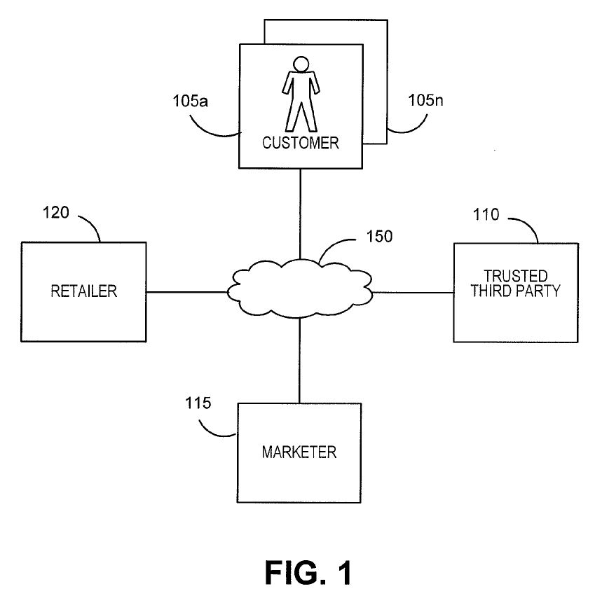

The present invention, in certain of its aspects, may provide an interactive coupon or offer system and method. FIG. 1 is an illustrative block diagram of a system, in accordance with the present invention, generally represented by reference numeral 100. System 100 includes at least one customer 105a-105n, a trusted third party (TTP) 110, and a marketer 115. System 100 may also include or interact with a retailer 120. The components of system 100 may communicate with other and other entities (not shown) via network 150.

The presence and actions of customer 105 may be facilitated by hardware, software, and combinations thereof to carry out actions the customer. In some embodiments, customer 105 may interface with a device, system, or subsystem that communicates and interacts with TTP 110, marketer 115, and retailer 120. Customer 105 may include a PC, a smart phone, a web-enabled mobile phone, a dedicated communication device, and a multimedia communication device including a processor and access to a memory. Actions of customer 105 may also be carried out by a server or server applet.

Similar to customer 105, TTP 110 and marketer 115 may, in some instances, be effectuated by hardware, software, and combinations thereof to carry out actions discussed herein. In some embodiments, TTP 110 and marketer 115 may interface with a device, system, subsystem, and other components and devices that communicate and interact with customer 105. Embodiments of TTP 110 and marketer 115 may include a PC, a server, a smart phone, a web-enabled mobile phone, a dedicated communication, and a multimedia communication device including a processor and access to a memory.

Retailer 120 may, at least in some embodiments, include an ability to communicate electronically with marketer 115.

It is noted that communication between customer 105, TTP 110, and marketer 115 may be established on a less than persistent basis. That is, communication links between customer 105, TTP 110 and marketer 115 may be established (and terminated) periodically, as-needed, or on an ad hoc basis.

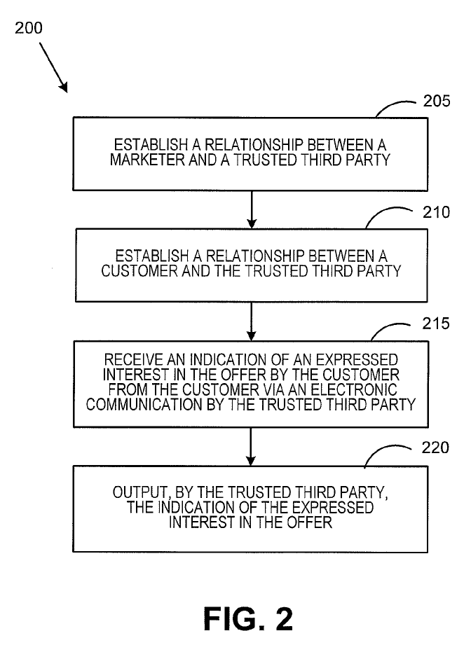

Referring to FIG. 2, there is shown a flow diagram of a process 200, in accordance with some embodiments herein. At operation 205, a relationship is established between marketer 115 and trusted third party 110. The relationship between marketer 115 and TTP 110 may include marketer 115 establishing a profile with TTP 110. The profile may define privacy rules regarding information exchanged between marketer 115 and TTP 110. In some embodiments, the privacy rules may limit or otherwise set boundaries regarding the nature and extent of information TTP 110 is permitted to reveal to marketer 115 concerning, for example, customer 105. In some aspects herein, the profile may control what information TTP 110 reveals to marketer 115 regarding customer 105 responding, if at all, to an offer presented to customer 105 by the marketer.

At operation 210, a relationship is established between customer 105 and TTP 110. The relationship may be established when a customer signs up with TTP 110 to create or edit a customer profile with the TTP. The sign-up process may be accomplished electronically. The profile may define or control the extent of communication and actions between customer 105 and TTP 110.

Marketer 115 may communicate with customer 105 to convey an offer to the customer. As used herein, an offer may be an invitation, a coupon, a discount code, a promotional code, or other information content to promote a customer to make a purchase a products, goods, or services associated with the offer. The offer may be presented to the customer in a variety of manners, including, for example, printed content, direct mailings, and electronic advertisements (e.g., radio, television, and on-line ads).

In some embodiments, the offer may be personalized per the customer. That is, the offer is directly prepared for customer 105. As such, the offer may be associated with the particular customer (e.g., 105a) for whom it is personalized. Further, the personalized offer may, at some downstream process or operation, be identified as being associated with the particular customer (e.g., 105a). In some embodiments, the offer may be generic to customer 105. That is, the offer is not specifically personalized for a particular customer. Generic content may include, for example, broad-based billboard signage, radio advertisement, newspaper advertisement, etc.

At operation 215, TTP 110 may electronically receive from customer 105 an indication of an expressed interest in the offer by the customer. Customer 105 may become aware of the offer through a personalized solicitation or generic advertisement. Customer 105 may communicate an interest in the offer (i.e., an expressed interest) in a particular offer by logging onto a network, system, device, presence, or other embodiment of TTP 110 and providing an indication of the interest to TTP 110.

Customer 105 may provide the indication of expressed interest to TTP 100 by entering a promotional, coupon, invitation, billboard, or bar code. Other types and forms of indicia may be provided by customer 105 to convey that the customer has expressed an interest in the offer.

In some embodiments, the expressed interest in the offer communicated to TTP 110 is an action other than a purchase associated with the offer. For example, the expressed interest other than a purchase may include viewing the offer by the customer, saving the offer by the customer, associating the offer with the customer, notifying others of the offer by the customer, comparing the offer with other offers, a request to activate the offer by the customer, declining to participate in the offer by the customer, combinations thereof, and other actions by the customer in response to the offer other than a purchase.

At operation 220, TTP 110 may output, to marketer 115, for example, information associated with the indication of the expressed interest in the offer. The output of the information associated with indication of the expressed interest in the offer provides a mechanism for the marketer to become aware of, for example, the effectiveness of the offer to the customer. Since the expressed interest is related to an action other than a purchase, the marketer is provided insight into the effectiveness of the offer for actions other than a purchase.

Further, marketer 115 may use the information associated with indication of the expressed interest to refine, revise, reinforce, or otherwise modify the offer to enhance the offer. In some embodiments, marketer 115 may use the information associated with the indication of the expressed interest in the offer to improve the effectiveness of the offer (based on, for example, criteria of marketer 115 and/or retailer 120 and the relationship therebetween).

In some aspects hereof, TTP 110 sends statistics and other information regarding the type of interest expressed by customer 105 to marketer 115. In some instances, some customer identifying data is conveyed to marketer 115. The type and extent of the customer identifying data conveyed to marketer 115 be determined based on, for example, at least one of the relationships between the customer and the trusted third party, a relationship between the customer and the offer, and the relationship between the marketer and the trusted third party. In some aspects, the customer identifying data may include demographic information associated with the customer. In some embodiments, the information conveyed may, if at all, include data regarding individual customers and/or data regarding groups/segments of customers.

In some embodiments, including an instance when the offer is generic, the offer may require or include an ability to be activated. Activation of the offer may include rendering the offer into a usable form by the TTP. In some embodiments, the TTP may initiate the activation at the direction of the customer. The activated offer may be electronically communicated to retailer 120 associated with the activated offer so that customer 105 may make a purchase or take other actions associated with the offer. In some embodiments, customer 105 need not physically or even electronically present the offer to a retailer. Instead, customer 105 may notify TTP 110 of the expressed interest in the offer and TTP 110 activates the offer and transmits proof of the activation to retailer 120.

In some embodiments, marketer 115 may notify TTP 110 to modify at least one term of the offer. The terms of the offer may be modified at the urging of the marketer to update the offer in response to, for example, changing customer and/or market forces. Offers may be modified to expire, increase in value, decrease in value, change in length of time it is valid, etc.

In some aspects of the present invention, TTP 110 may notify marketer 115 of a customer's preferences or interest related to specific orders. Such notification may facilitate marketer 115 or a potential marketer of customer's preferences so that marketing efforts can be enhanced.

In some aspects herein, TTP 110 may process information related to the expressed interest in the offer by the customer and further create a record of the processing. Such processing and record keeping may be beneficial to enhancing, maintaining, or justifying a marketing offer or campaign.

In another aspect of the invention herein, marketer 115 may notify TTP 110 that the customer has activated an offer or made a purchase associated with the offer. In this manner, the TTP may be notified of the receipt of an activated offer (e.g., a purchase associated with the offer). This aspect of the present invention may facilitate a mechanism to provide marketing response details to TTP 110. TTP 110 may use the marketing response details to, for example, improve the effectiveness and efficiency of a marketing offer.

Regarding customer 105, the customer may, in the context of system 100 and the methods herein, log onto system 100 to periodically check for modified, new, expired offers associated with their profile.

TTP 110 may notify customer 105 of changes to the offer. Customer 105 may request activation of an offer, where required or as an option, by TTP 110. Upon activation of an offer, customer 105 may receive, electronically or physically, a usable form of the offer.

In some embodiments of the present invention, TTP 110 may activate an auction or auction-like process on behalf of at least one customer 105. The auction may be initiated to, for example, motivate marketers to provide better offers. For example, TTP may be informed that a customer is interested in a particular one or category of offer. To further interests, TTP may initiate an auction to get marketers to compete for the customer's interest by participating in the auction to win the customer's interest.

The system and methods disclosed herein may be implemented, facilitated, and advanced by code, instructions, and software embodied on a medium. The medium may include any current known and future known medium, including a memory. The code, instructions, and software embodied on the medium may be at least accessible to a processor that operates to execute the code, instructions, and software embodied on the medium.

The above description and the flow charts herein are not meant to imply a fixed order of the enumerated process steps. Rather, the process steps may be performed in any order that is practicable.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
establishing a relationship between a marketer and a trusted third party;
establishing a relationship between a customer and the trusted third party;
receiving, by the trusted third party from the customer via an electronic communication, an indication of an expressed interest in an offer by the customer, the expressed interest being an action other than a purchase associated with the offer; and
outputting, by the trusted third party, information associated with the indication of the expressed interest in the offer to the marketer.

2. The method of claim 1, wherein the offer to the customer is one of a personalized offer and a generic offer.

3. The method of claim 1, further comprising activation of the offer to a usable form by the trusted third party.

4. The method of claim 2, wherein the trusted third party initiates the activation at the direction of the customer.

5. The method of claim 3, wherein the activated offer is electronically communicated to a retailer associated with the activated offer.

6. The method of claim 1, wherein the trusted third party keeps private from the marketer at least a portion of customer identifying data based on at least one of the relationship between the customer and the trusted third party, a relationship between the customer and the offer, and the relationship between the marketer and the trusted third party.

7. The method of claim 4, further comprising providing demographic information associated with the customer to the marketer by the trusted third party.

8. The method of claim 1, further comprising:
processing, by the trusted third party, the expressed interest in the offer by the customer; and
creating a record of the processing.

9. The method of claim 1, wherein the expressed interest in the offer by the customer is selected from the group consisting of: viewing of the offer by the customer, saving the offer by the customer, associating the offer with the customer, notifying others of the offer by the customer, comparing the offer with other offers, a request to activate the offer by the customer, declining to participate in the offer by the customer, and combinations thereof.

10. The method of claim 1, further comprising the marketer notifying the trusted third party to modify at least one term of the offer.

11. The method of claim 1, further comprising the trusted third party notifying the marketer of customer preferences associated with the offer.

12. The method of claim 1, further comprising the marketer notifying the trusted third party that the customer has made a purchase associated with the offer.

13. The method of claim 1, further comprising initiating an auction regarding a plurality of offers on a behalf of the customer by the trusted third party, wherein the auction is initiated based on the relationship between the trusted third party and the marketer.

14. A system comprising:
a memory storing processor-executable instructions; and
a processor in communication with the memory and operative in conjunction with the memory to execute the stored instructions to:
establish a relationship between a marketer and a trusted third party;
establish a relationship between a customer and the trusted third party;
receive, by the trusted third party from the customer via an electronic communication, an indication of an expressed interest in an offer by the customer, the expressed interest being an action other than a purchase associated with the offer; and
output, by the trusted third party, information associated with the indication of the expressed interest in the offer to the marketer.

15. The system of claim 14, wherein the processor is further operative to activate the offer to a usable form by the trusted third party.

16. The system of claim 15, wherein the trusted third party initiates the activation at the direction of the customer.

17. The system of claim 14, wherein the activated offer is electronically communicated to a retailer associated with the activated offer.

18. The system of claim 14, wherein the trusted third party keeps private from the marketer at least a portion of customer identifying data based on at least one of the relationship between the customer and the trusted third party, a relationship between the customer and the offer, and the relationship between the marketer and the trusted third party.

19. The system of claim 14, wherein the processor is further operative to:
process, under control of the trusted third party, the expressed interest in the offer by the customer; and
create a record of the processing.

20. The system of claim 14, wherein the expressed interest in the offer by the customer is selected from the group consisting of: viewing of the offer by the customer, saving the offer by the customer, associating the offer with the customer, notifying others of the offer by the customer, comparing the offer with other offers, a request to activate the offer by the customer, declining to participate in the offer by the customer, and combinations thereof.

21. The system of claim 14, wherein the processor is further operative to notify the trusted third party that the customer has made a purchase associated with the offer.

22. The system of claim 14, wherein the processor is further operative to initiate an auction regarding a plurality of offers on a behalf of the customer by the trusted third party, wherein the auction is initiated based on the relationship between the trusted third party and the marketer.

23. A medium having machine-executable instructions stored therein, the medium comprising:
instructions to establish a relationship between a marketer and a trusted third party;
instructions to establish a relationship between a customer and the trusted third party;
instructions to receive, by the trusted third party from the customer via an electronic communication, an indication of an expressed interest in an offer by the customer, the expressed interest being an action other than a purchase associated with the offer; and
instructions to output, by the trusted third party, information associated with the indication of the expressed interest in the offer to the marketer.
